(19) United States
(12) Patent Application Publication
(10) Pub. No.: US 2009/0178424 A1
(43) Pub. Date: Jul. 16, 2009

(54) Air conditioner

(75) Inventors: Sun Ho Hwang, Changwon-si (KR); Han Su Jung, Changwon-si (KR); Chung Hun Lee, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/318,057

(22) Filed: Dec. 19, 2008

(30) Foreign Application Priority Data
Dec. 21, 2007 (KR) 10-2007-0135489

(51) Int. Cl. F25D 23/00; G05D 23/00

(52) U.S. Cl. 62/259.1; 62/157

(57) ABSTRACT

In an air conditioner including a plurality of outdoor units, a first outdoor unit includes: a converter that receives commercial AC power and converts the received commercial AC power into DC power; and at least one first outdoor fan inverter that converts the DC power into AC power to drive a motor for at least one first outdoor fan, and a second outdoor unit includes: at least one second outdoor fan inverter that receives the DC power which has been converted by the converter and converts the received DC power into AC power to drive a motor for at least one second outdoor fan.

### TECHNICAL FIELD

The present invention relates to an air-conditioner and, more particularly, to a multi-type air conditioner in which DC power is commonly used.

### BACKGROUND ART

An air conditioner is an apparatus installed in spaces such as rooms, living rooms, offices, business stores, or the like, in order to control temperature, humidity, cleanness and air streams to maintain an agreeable, comfortable indoor environment.

In general, the air conditioner is divided into an integration type air conditioner and a separation type air conditioner. The integration type air conditioner and the separation type air conditioner have the same function, but the integration type air conditioner having integrated cooling and heat releasing functions is installed in a hole made in the wall of a house or installed on a frame hung up on a window of the house, while the separation type air conditioner includes an indoor unit installed at an inner side of a building to perform cooling and heating operations and an outdoor unit installed at an outer side of the building to perform heat releasing and compression functions, the indoor and outdoor units being connected by a refrigerant pipe.

A motor is used for a compressor, a fan, or the like, of the air conditioner, and a motor control device is used to drive the motor. The motor control device of the air conditioner receives commercial AC power, converts the AC power into a DC voltage, converts the DC voltage into commercial AC power of a certain frequency, and supplies the same to the motor to control driving of the motor of the compressor, the fan, or the like.

Meanwhile, a multi-type air conditioner using a plurality of indoor units over a single outdoor unit or a plurality of indoor units over a plurality of outdoor units is employed to be used in consideration of the capacity or efficiency of the air conditioner. The multi-type air conditioner includes many components, so a reduction of the fabrication cost and effective disposition of the multi-type air conditioner are being discussed.

### DISCLOSURE

### Technical Problem

An object of the present invention is to provide an air conditioner capable of reducing a fabrication cost by commonly using DC power.

### Technical Solution

To achieve the above object, there is provided an air conditioner including a plurality of outdoor units, wherein a first outdoor unit includes: a converter that receives commercial AC power and converts the received commercial AC power into DC power; and at least one first outdoor fan inverter that converts the DC power into AC power to drive a motor for at least one first outdoor fan, and a second outdoor unit includes: at least one second outdoor fan inverter that receives the DC power which has been converted by the converter and converts the received DC power into AC power to drive a motor for at least one second outdoor fan.

### ADVANTAGEOUS EFFECTS

The air conditioner according to the present invention has an advantage in that because DC power is commonly used, the fabrication cost can be reduced. In addition, because a control unit is effectively disposed in a control box of an outdoor unit, the performance and stability can be enhanced.

The foregoing and other objects, features, aspects and advantages of the present invention will become more apparent from the following detailed description of the present invention when taken in conjunction with the accompanying drawings.

### DESCRIPTION OF DRAWINGS

FIG. 1 is an air view showing installation of an air conditioner according to an embodiment of the present invention.

FIG. 2 illustrates the air conditioner in FIG. 1.

FIG. 3 is a view showing the structure of the air conditioner in FIG. 1.

FIG. 4 is a block diagram of the air conditioner according to an embodiment of the present invention.

FIGS. 5a and 5b show a control box of an outdoor unit of the air conditioner according to an embodiment of the present invention.

FIG. 6 is a block diagram of an air conditioner according to an embodiment of the present invention.

FIG. 6 is a block diagram of an air conditioner according to an embodiment of the present invention.

### MODE FOR INVENTION

Embodiments of the present invention will now be described in detail with reference to the accompanying drawings.

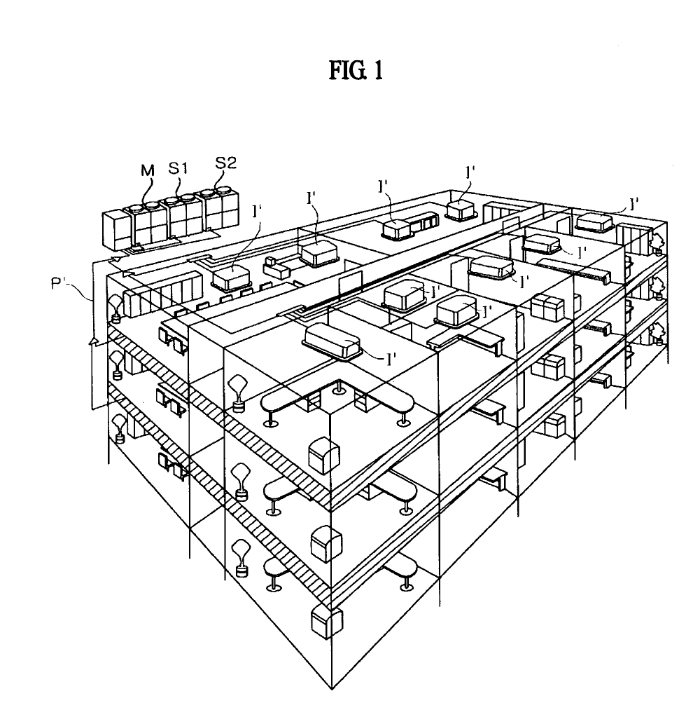

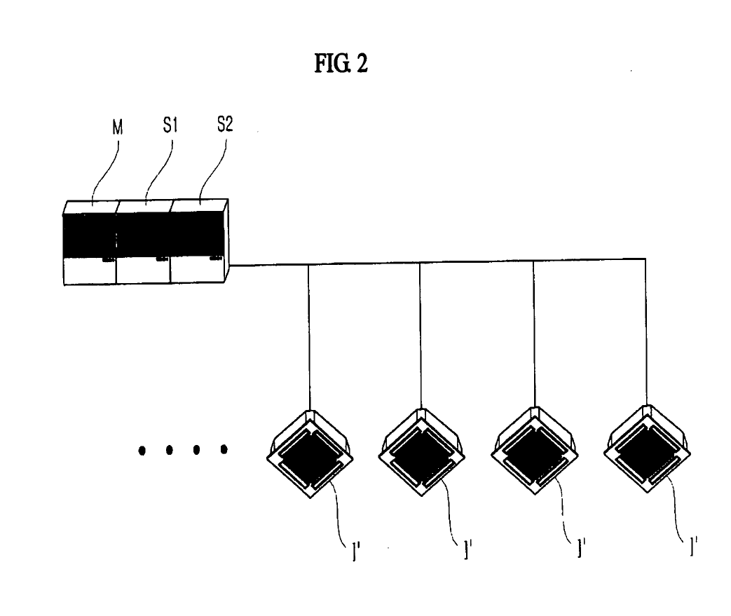

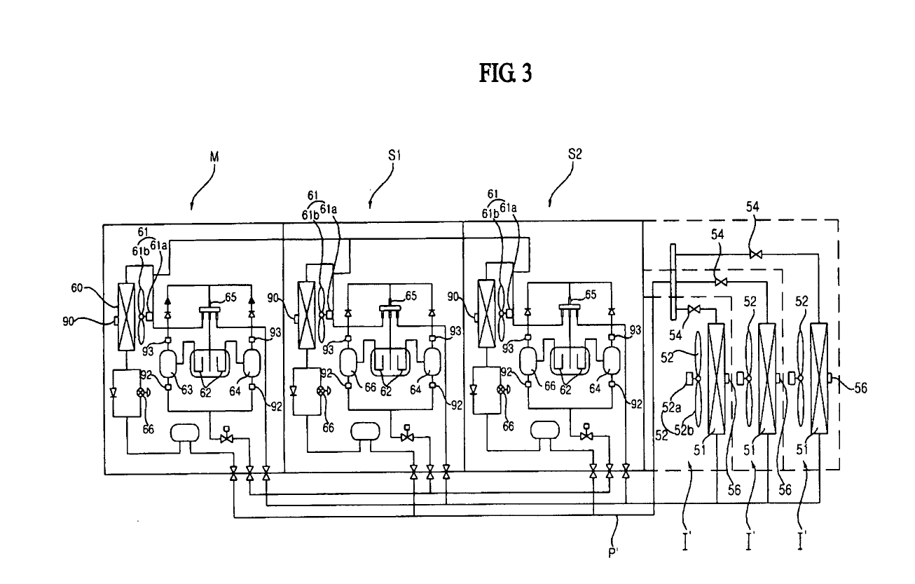

FIG. 1 is an air view showing installation of an air conditioner according to an embodiment of the present invention, FIG. 2 illustrates the air conditioner in FIG. 1, and FIG. 3 is a view showing the structure of the air conditioner in FIG. 1.

With reference to FIGS. 1 to 3, the air conditioner includes a plurality of indoor units I″ installed in a building to perform cooling or heating operation, a plurality of outdoor units M, S1, and S2 connected with the indoor units I′ through a refrigerant pipe P′, and a control unit (not shown) that controls the indoor units I′ and the out door units M, S1, and S2.

The outdoor units M, S1, and S2 are driven according to a request of at least one of the indoor units I′, and as the cooling/heating capacity requested by the indoor units I′ is increased, the operation number of the outdoor units M, S1, and S2 and the operation number of compressors installed in the outdoor units M, S1, and S2 is increased.

Each indoor unit I′ includes an indoor heat exchanger 51 whose refrigerant is heat-exchanged with indoor air of each room in which each indoor unit I′ is installed, an indoor air blower 52 that blows indoor air of each room in which each indoor unit I′ is installed to the indoor heat exchanger 51, and an indoor electronic expansion valve 54, namely, an indoor flow quantity adjusting unit, controlled according to a supercooling degree and a superheating degree during a cooling operation.

When the air conditioner performs cooling, the indoor heat exchanger 51 serves as an evaporator to suck a liquid phase refrigerant and cool indoor air as the sucked liquid phase refrigerant evaporates by air of the room in which the indoor unit I′ that has requested the cooling operation is installed. When the air conditioner performs heating, the indoor heat exchanger 51 serves as a condenser to suck a gas phase refrigerant and increase the temperature of the indoor air as the sucked gas phase refrigerant is condensed by air of the room in which the indoor unit I that has requested the heating operation is installed.

The indoor heat exchanger 51 may include an indoor temperature sensing unit 56 that senses the temperature of the refrigerant passing through the indoor heat exchanger 51.

The indoor air blower 52 includes an indoor motor 52a controlled by an indoor control unit (not shown) to generate power, and an indoor fan 52b connected with the indoor motor 52a and rotated by the indoor motor 52a to generate air blowing force.

The plurality of outdoor units M, S1 and S2 refer to a main outdoor unit (M) operating always regardless of a load of the indoor unit I′, and sub-outdoor units S1 and S2 selectively operating according to a load of the indoor unit I′.

The main outdoor unit (M) and the sub-outdoor units S1 and S2 include an outdoor heat exchanger 60 whose refrigerant is heat-exchanged with outdoor air, an outdoor air blower 61 that blows outdoor air to the outdoor heat exchanger 60, an accumulator 62 that extracts only a gaseous refrigerant, two compressors 63 and 64 that compress the gaseous refrigerant extracted by the accumulator 62, a four-way valve 65 that switches a flow of the refrigerant, and an outdoor electronic expansion valve 66, namely, an outdoor flow quantity adjusting unit 66, controlled according to a supercooling degree or a superheating degree during a heating operation, respectively.

The outdoor heat exchanger 60 may include an outdoor temperature sensing unit 90 that senses the temperature of the outer side of the building where the outdoor units M, S1, and S2 are installed.

The outdoor air blower 61 includes an outdoor motor 61a controlled by an outdoor control unit (not shown) to generate power, and an outdoor fan 61b connected with the outdoor motor 61a and rotated by power of the outdoor motor 61a to generate air blowing force.

One of the two compressors 63 and 64 of the main outdoor unit (M) may be an inverter compressor and the other may be a constant speed compressor. Meanwhile, the two compressors 63 and 64 of the sub-outdoor units S1 and S2 may be both constant speed compressors.

A low pressure sensing unit 92 and a high pressure sensing unit 93 that sense a sucking/discharging pressure of the compressors 63 and 64 may be provided at a suction side and a discharge side.

The accumulator 62 may be connected to the two compressors 63 and 64 so as to be commonly used.

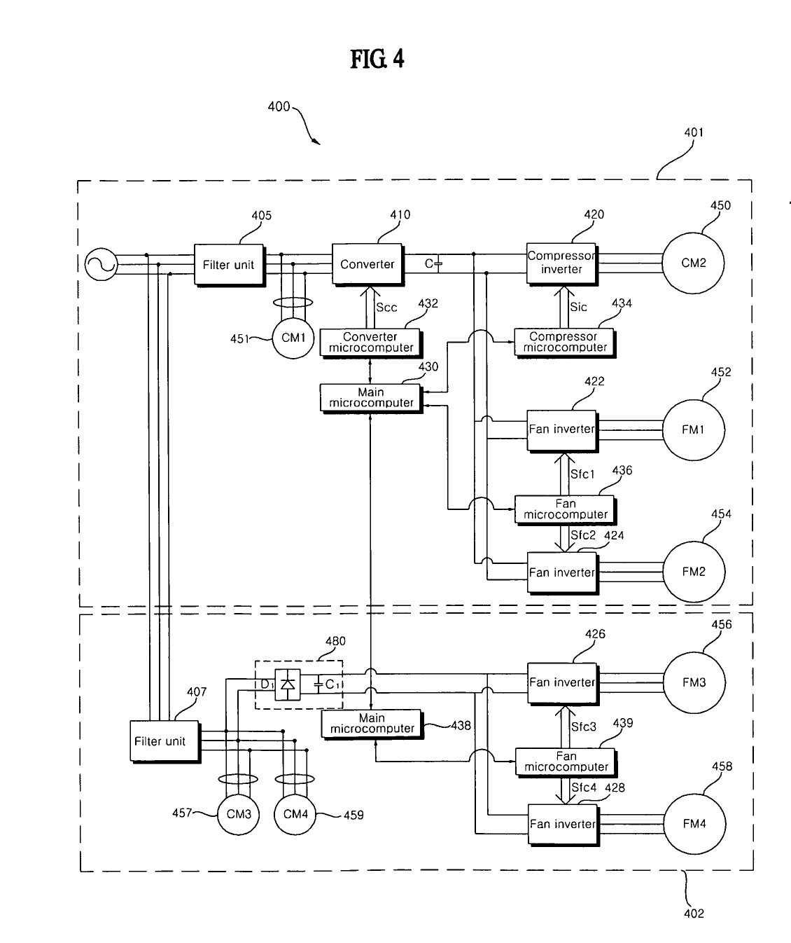

FIG. 4 is a block diagram of an air conditioner according to an embodiment of the present invention.

With reference to FIG. 4, an air conditioner 400 according to an embodiment of the present invention includes a plurality of outdoor units. Among the plurality of outdoor units, a first outdoor unit 401 includes a converter 410, fan inverters 422 and 424, and fan motors 452 and 454, and a second outdoor unit 402 includes fan inverters 426 and 428 and fan motors 456 and 458.

The first outdoor unit 401 further includes a compressor inverter 420, a compressor microcomputer 434, a fan microcomputer 436, a main microcomputer 430, an inverter compressor 450, a constant speed compressor 451, a filter unit 405, and a smoothing capacitor (C).

Also, the second outdoor unit 402 further includes a fan microcomputer 439, a main microcomputer 438, constant speed compressors 457 and 459, and a filter unit 407.

First, the first outdoor unit 401 will be described as follows.

The filter unit 405 cancels a noise component between the commercial AC power and the converter 410. For this purpose, the filter unit 405 serves as a noise filter. The noise filter may include passive elements such as a resistor, an inductor, a capacitor, or the like, but it may also include an active element in addition.

Although not shown, a plurality of reactors may be provided in addition to the filter unit 405. The reactors correct a power factor and serve to boost the commercial AC power by cooperatively operating with the converter 410 having a switching element and restrict a harmonic current component together with the noise filter.

The converter 410 converts the commercial AC power into DC power and outputs the same. The commercial AC power may be three-phase AC power as shown in FIG. 4, and also may be single-phase AC power without being limited thereto. The internal structure of the converter 410 may differ depending on the type of the commercial AC power. For example, in case of the single-phase AC power, a half-bridge type converter in which two switching elements and four diodes are connected may be used. In case of the three-phase AC power, six switching elements and six diodes may be used. The converter 410 includes a plurality of switching elements to perform a boosting operation, improve a power factor, and DC power conversion. Of course, only a diode may be used as the converter 410.

The smoothing capacitor (C) is connected with an output terminal of the converter 410, and smoothes the converted DC power outputted from the converter 410. Hereinafter, the output terminal of the converter 410 will be called a dc terminal or a dc link terminal. DC power smoothed at the dc terminal is also called a dc terminal voltage.

The DC power (dc terminal voltage) is applied to the compressor inverter 420, the fan inverters 422 and 424, and the fan inverters 426 and 428 of the second outdoor unit. Because the dc terminal voltage is used by the plurality of outdoor units by using the single converter 410 provided in the first outdoor unit 401, the fabrication cost can be reduced.

The compressor inverter 420 includes a plurality of inverter switching elements, converts DC power (dc terminal voltage) into three-phase AC power of a certain frequency, and outputs the same, according to ON/OFF operations of the switching elements. In detail, in the compressor inverter 420, a serially connected upper and lower arm switching elements make a pair, and a total three pairs of upper and lower arm switching elements are connected in parallel.

The three-phase AC power outputted from the compressor inverter 420 is applied to each phase of the compressor motor 450. Here, the compressor motor 450 includes a stator and a rotor, and as each phase AC power of a certain frequency is applied to a coil of the stator of each phase, the rotor rotates. The compressor motor 450 may be a BLDC motor, but without being limited thereto, various types of motors such as an induction motor or an synRM motor, etc., may be used.

The compressor microcomputer 434 outputs a switching control signal Sic to control the compressor inverter 420. The switching control signal Sic is a PWM switching control signal that can be generated based on an output current flowing across the compressor motor 450 or an induced counter electromotive force.

The fan inverters 422 and 424 are similar to the compressor inverter 420. Namely, the fan inverters 422 and 424 include a plurality of inverter switching elements, convert smoothed DC power into three-phase AC power of a certain frequency, and output the same, according to ON/OFF operations of the switching elements. The three-phase AC power drive the fan motors 452 and 454. The fan motors 452 and 454 may be BLDC motors, but without being limited thereto, various types of motors such as an induction motor or an synRM motor, etc., may be used.

The fan microcomputer 436 outputs switching control signals Sfc1 and Sfc2 to control the fan inverters 422 and 424. The switching control signals Sfc1 and Sfc2 are PWM switching control signals and may be generated based on an output current flowing across the fan motors 452 and 454 or based on a position signal by a sensor attached within the fan motors 452 and 454.

The fan microcomputer 436 controls the plurality of fan inverters 422 and 424 together as shown in FIG. 4. Thus, the number of microcomputers can be reduced to obtain an effect of cost reduction.

The converter microcomputer 432 outputs a switching control signal Scc to control the converter 410. The switching control signal Scc may be generated based on an input current from the commercial AC power and the dc terminal voltage. Also, the switching control signal Scc may be generated based on zero crossing of the input voltage from the commercial AC power.

The main microcomputer 430 controls operations of the converter microcomputer 432, the compressor microcomputer 434, and the fan microcomputer 436. In addition, the main microcomputer 430 performs communication with an indoor unit (not shown), the second outdoor unit 402, or the like.

The constant speed compressor 451 is driven at a certain speed by directly using the commercial AC power, without using the compressor inverter. Thus, the constant speed compressor 451 does not use the above-described DC power (dc terminal voltage). But in order to cancel noise or harmonics, the constant speed compressor 451 operates by using the commercial AC power that has passed through the above-described filter unit 405. Because the constant speed compressor 451 is used in addition to the inverter compressor 450, a heavy load required by an indoor unit can be managed.

The second outdoor unit 402 will be described as follows.

The filter unit 407 is similar to the filter unit 405 of the first outdoor unit 401. The filter unit 407 may be a noise filter that cancels a noise component between the commercial AC power and the constant speed compressors 457 and 459.

The fan inverters 426 and 428 include a plurality of inverter switching elements, convert DC power (dc terminal voltage) which has been generated through the converter 410 and the smoothing capacitor (C) of the first outdoor unit 401 into three-phase AC power of a certain frequency, and outputs the same, according to ON/OFF operations of the switching elements. The three-phase AC power of a certain frequency drives the fan motors 456 and 458. The fan motors 456 and 458 may be BLDC motors, but without being limited thereto, various types of motors such as an induction motor or an synRM motor, etc., may be used.

The fan microcomputer 439 outputs switching control signals Sfc3 and Sfc4 to control the fan inverters 426 and 428. The switching control signals Sfc3 and Sfc4 are PWM switching control signals and may be generated based on an output current flowing across the fan motors 456 and 458 or based on a position signal by a sensor attached within the fan motors 456 and 458.

The fan microcomputer 439 controls the plurality of fan inverters 426 and 428 together as shown in FIG. 4. Thus, the number of microcomputers can be reduced to obtain an effect of cost reduction.

The main microcomputer 438 controls an operation of the above-described fan microcomputer 439. In addition, the main microcomputer 438 performs communication with the first outdoor unit 401.

The constant speed compressors 457 and 459 are driven at a certain speed by directly using the commercial AC power, without using an inverter. Thus, the constant speed compressors 45u and 459 do not use the above-described DC power (dc terminal voltage). But in order to cancel noise or harmonics, the constant speed compressors 457 and 459 operate by using the commercial AC power that has passed through the filter unit 407.

In FIG. 4, the first outdoor unit 401 operates as a main outdoor unit, and the second outdoor unit 402 operates as a sub-outdoor unit. The air conditioner 400 according to the embodiment of the present invention may further include a third outdoor unit operating as a sub-outdoor unit as shown in FIGS. 1 to 3.

The above-described converter microcomputer 432 may further include a current command generating unit that generates a current command value based on a detected dc terminal voltage Vdc and a dc terminal voltage command value, a voltage command generating unit that generates a voltage command value based on the generated current command value and an input current inputted from the general AC power, and a switching control signal output unit that generates a PWM switching control signal based on the voltage command value.

The compressor microcomputer 434 or the fan microcomputer 436 may further include an estimating unit that estimates a speed based on an output current flowing across each motor, a current command generating unit that generates a current command value based on the estimated speed and a speed command value, a voltage command generating unit that generates a voltage command value based on the generated current command value and the output current, and a switching control signal output unit that generates a PWM switching control signal based on the voltage command value.

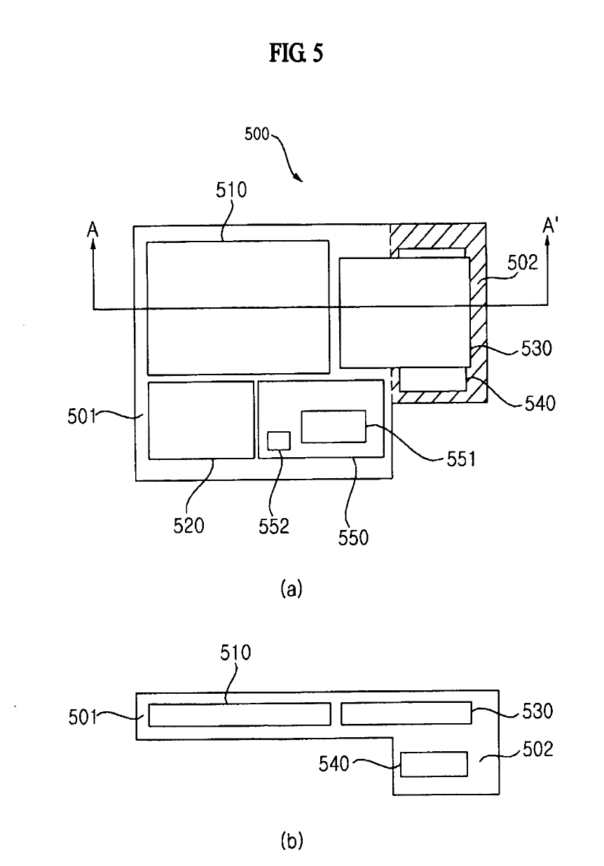

FIGS. 5a and 5b show a control box of an outdoor unit of the air conditioner according to an embodiment of the present invention.

FIG. 5a is a front view showing a control box 500 in the first outdoor unit in FIG. 4, and FIG. 5b is a sectional view taken along line A-A′ in FIG. 5a.

With reference to FIGS. 5a and 5b, respective elements of the first outdoor unit 401 of the air conditioner are divided to be mounted on a plurality of substrates. Elements having the similar function or elements performing correlated operations are mounted on the same substrate or on an adjacent substrate.

First, the compressor inverter 420 is mounted on a first substrate 510. The first outdoor fan inverters 422 and 424 are mounted on a second substrate 520. The main microcomputer 430 is mounted on a third substrate 530. The filter unit 405 is mounted on a fourth substrate 540, and a terminal 551 to which the commercial AC power is connected is mounted on a fifth substrate 550.

On the first substrate 510, the converter 10 may be further mounted. Also, the compressor microcomputer 434 and the converter microcomputer 432 may be further mounted on the first substrate. The fan microcomputer 436 may be further mounted in addition to the fan inverters 422 and 424 on the second substrate 520. A plurality of reactors (not shown) may be further mounted on the fourth substrate 530. A connection terminal 552 to which the constant compressor 451 may be further mounted on the fifth substrate 550.

The first and second substrates are disposed to be adjacent to each other. Because the compressor inverter 420 and the fan inverters 422 and 424 have similar functions, they are preferably disposed to be adjacent.

The first and third substrates 510 and 530 may be disposed to be adjacent. The compressor inverter 420, the compressor microcomputer 434, and the main microcomputer 430 operate in association with each other.

Namely, if a speed command from the main microcomputer 430 is transferred to the compressor microcomputer 434, the compressor microcomputer 434 generates the PWM switching control signal Sic of a certain frequency and controls the compressor inverter 420.

The fourth and fifth substrates 540 and 550 are disposed to be adjacent to each other. When the commercial AC power is supplied via the terminal 551 to which the commercial AC power is connected, it is directly applied to the filter unit 405 to cancel noise or remove a harmonic component included therein.

Because the filter unit 405 performs the function of canceling noise or removing a harmonic component, it may be disposed such that its electronic or magnetic influence on other elements is minimized. For this, the embodiment of the present invention proposes a method for disposing the filter unit 405 on a different plane.

Namely, among the first to fifth substrates 510 to 550, the other substrates than the fourth substrate 540 may be disposed at a first region 501, namely, within the same plane, and the fourth substrate 540 may be disposed at a second region 502, a different plane from that of the first region 501. The second region 502 refers to a step region of the first region 501. Namely, the fourth substrate 540 may be disposed at a lower portion of the third substrate 530.

The first and third substrates 510 and 530 may be disposed side by side on a first side surface, and the second and third substrates 520 and 530 may be disposed side by side on a second side surface facing the first side surface. With reference to FIG. 4, the first substrate 510 including the converter 410, the converter microcomputer 432, the compressor microcomputer 434, and the compressor inverter 420, and the third substrate 530 including the main microcomputer 430 can be disposed to be parallel. In addition, the second substrate 520 including the fan inverters 422 and 424 and the fan microcomputer 436, and the fifth substrate 550 including the terminal 551 that supplies the commercial AC power can be disposed to be parallel.

The first and second substrates 510 and 520 may be disposed on a third side surface perpendicular to the first side surface. The first substrate 510 including the converter 410, the converter microcomputer 432, the compressor microcomputer 434, and the compressor inverter 420, and the second substrate 520 including the fan inverters 422 and 424 and the fan microcomputer 436 may be disposed to be adjacent to each other because they have the similar function, and may be disposed on the third side surface, namely, on the same side surface.

The third and fourth substrates 530 and 540 may be disposed on a fourth side surface facing the third side surface.

A control box of the second outdoor unit may be similar to that of the first outdoor unit. Namely, respective elements of the second outdoor unit 402 are divided to be mounted on a plurality of substrates. Elements having the similar function or elements performing correlated operations are mounted on the same substrate or on an adjacent substrate.

The second outdoor unit does not include a compressor inverter, a compressor microcomputer, a converter, and a converter microcomputer, so the first substrate may be omitted.

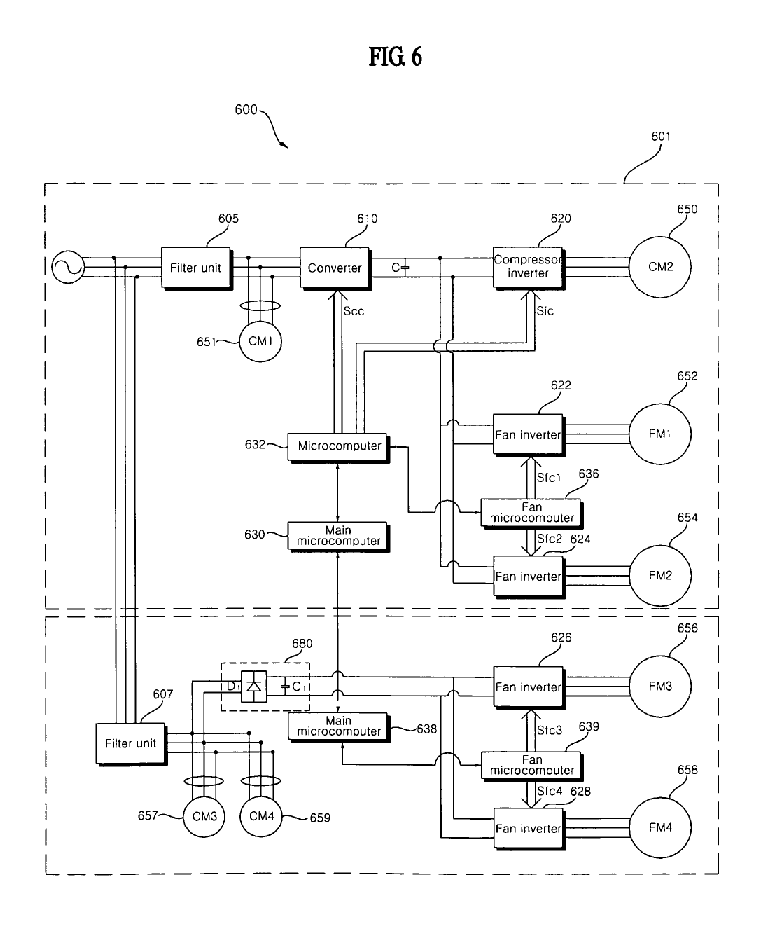

FIG. 6 is a block diagram of an air conditioner according to an embodiment of the present invention.

With reference to FIG. 6, an air conditioner 600 according to an embodiment of the present invention includes a plurality of outdoor units. A first outdoor unit 601 includes a converter 610, fan inverters 622 and 624, and fan motors 652 and 654, and the second outdoor unit 602 includes fan inverters 626 and 628, and fan motors 656 and 658.

The first outdoor unit 601 further includes a compressor inverter 620, a microcomputer 632, a main microcomputer 630, a fan microcomputer 636, an inverter compressor 650, a constant speed compressor 651, a filter unit 605, and a smoothing capacitor (C).

The second outdoor unit 602 further includes a fan microcomputer 639, a main microcomputer 638, constant speed compressors 657 and 659, and a filter unit 607.

The air conditioner 600 in FIG. 6 is similar to the air conditioner 400 in FIG. 4, and different in that the air conditioner 600 uses a single common microcomputer 632 instead of the converter microcomputer 432 and the compressor microcomputer 43 of the air conditioner 400. Because the converter microcomputer 432 and the compressor microcomputer 434 may be mounted together on the substrate,

Namely, on the first substrate 510, as described above with reference to FIG. 5, they can be incorporated into the common microcomputer 632. Thus, the fabrication cost can be reduced.

As described above with reference to FIG. 4, the common microcomputer 632 may generate a converter switching control signal Scc and an inverter switching control signal Sic and output them. Besides, the common microcomputer 632 may perform an overvoltage or an overcurrent protection function.

Other elements are the same as those in FIG. 4, so its detailed description will be omitted.

### INDUSTRIAL APPLICABILITY

The air conditioner according to the present invention can be used for a multi-type air conditioner in which DC power is commonly used.

What is claimed is:

1. An air conditioner comprising a plurality of outdoor units, wherein:
a first outdoor unit of the plurality of outdoor units comprises:
a converter adapted to receive AC power from an AC power source and convert the received AC power into DC power; and
at least one first outdoor unit fan inverter adapted to convert the DC power into AC power to drive a motor of the at least one first outdoor unit fan, and
a second outdoor unit of the plurality of outdoor units comprises:
at least one second outdoor unit fan inverter adapted to convert the DC power into AC power to drive a motor of at least one first outdoor unit fan.

2. The air conditioner of claim 1, further comprising:
a compressor motor; and
a compressor inverter adapted to convert the DC power into AC power to drive the compressor motor.

3. The air conditioner of claim 2, wherein the first outdoor unit further comprises:
a first outdoor unit constant speed compressor driven by using the AC power.

4. The air conditioner of claim 1, wherein the second outdoor unit further comprises:
at least one second outdoor unit constant speed compressor driven by using the AC power.

5. The air conditioner of claim 2, wherein the first outdoor unit further comprises:
a converter microcomputer adapted to control a converter;
a compressor microcomputer adapted to control the compressor inverter;
a first outdoor unit fan microcomputer adapted to control the first outdoor unit fan inverter; and
a first outdoor unit main microcomputer that controls the microcomputers and performs communication with an indoor unit and the second outdoor unit.

6. The air conditioner of claim 1, wherein the second outdoor unit further comprises:
a second outdoor unit fan microcomputer that controls the second outdoor unit fan inverter; and
a second outdoor unit main microcomputer that controls the second outdoor unit fan microcomputer and performs communication with the first outdoor unit.

7. The air conditioner of claim 5, wherein the first outdoor unit fan microcomputer controls a plurality of first outdoor unit fan inverters together.

8. The air conditioner of claim 6, wherein the second outdoor unit fan microcomputer controls a plurality of second outdoor unit fan inverters together.

9. The air conditioner of claim 5, wherein the first outdoor unit further comprises:
a first outdoor unit filter unit that removes electrical noise between the AC power source and the converter.

10. The air conditioner of claim 6, wherein the second outdoor unit further comprises:
a second outdoor unit filter unit that cancels noise between the AC power and the constant speed compressor.

11. The air conditioner of claim 9, wherein the first outdoor unit comprises:
a first substrate on which the compressor inverter is mounted;
a second substrate on which at least one first outdoor unit fan inverter is mounted;
a third substrate on which the first outdoor unit main microcomputer is mounted;
a fourth substrate on which the first outdoor unit filter unit is mounted; and
a fifth substrate on which a terminal to which the AC power is connected is mounted.

12. The air conditioner of claim 11, wherein the first substrate further includes the converter mounted thereon.

13. The air conditioner of claim 12, wherein the first substrate further includes the compressor microcomputer and the converter microcomputer mounted thereon.

14. The air conditioner of claim 11, wherein the second substrate further includes the fan microcomputer mounted thereon.

15. The air conditioner of claim 11, wherein the fourth substrate further includes a plurality of reactors mounted thereon.

16. The air conditioner of claim 11, wherein the fifth substrate further includes the first outdoor unit constant speed compressor mounted thereon.

17. The air conditioner of claim 11, wherein the first and second substrates are disposed to be adjacent to each other.

18. The air conditioner of claim 11, wherein the first and third substrates are disposed to be adjacent to each other.

19. The air conditioner of claim 11, wherein the fourth and fifth substrates are disposed to be adjacent to each other.

20. The air conditioner of claim 11, wherein the fourth substrate is disposed below the third substrate.

21. The air conditioner of claim 11, wherein the first and third substrates are disposed on a first side surface, and the second and fifth substrates are disposed on a second side surface facing the first side surface.

22. The air conditioner of claim 21, wherein the first and second substrates are disposed on a third side surface perpendicular to the first side surface.

23. The air conditioner of claim 22, wherein the third and fourth substrates are disposed on a fourth side surface facing the third side surface.

24. The air conditioner of claim 13, wherein the compressor microcomputer and the converter microcomputer are a single common microcomputer.

25. The air conditioner of claim 1, wherein the first and second outdoor unit fan motors are BLDC motors.
